(19) United States
(12) Patent Application Publication
(10) Pub. No.: US 2009/0120165 A1
(43) Pub. Date: May 14, 2009

(54) Sampling Leak Detector

(76) Inventors: Peter Lang, Bonn (DE); Norbert Rolff, Horrem (DE); Sandra Seitz, Duesseldorf (DE); Werner Grosse Bley, Bonn (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/988,840

(22) PCT Filed: Jun. 9, 2006
(86) PCT No.: PCT/EP2006/063060

§ 371 Date: Jan. 15, 2008

(30) Foreign Application Priority Data
Jul. 20, 2005 (DE) 20 2005 011 372.7

(51) Int. Cl. G01M 3/04

(52) U.S. Cl. 73/40.7

(57) ABSTRACT

A sampling leak detector which comprises a basic device and a sniffling probe connected thereto via a tube. A visual display is located on the sniffling probe. A tactile indicator is provided in a handle. An acoustic indicator is arranged on the basic device. The detector can be switched to a detection mode in which the color in the visual display changes and the indicator are activated when a predetermined leakage rate is exceeded. The detector can also be switched to a locating mode in which leakage rate information is displayed by means of a bar of variable length and a sound is generated which has a parameter depending on the leakage rate information.

### BACKGROUND

1. Field of the Disclosure

The disclosure relates to a sampling leak detector comprising
a sniffling probe to be guided by a user, comprising a handle and a display means for displaying information on the detected leakage rate, and
a basic device comprising a suction means and a gas detector connected thereto, the sniffling probe being connected to the basic device via a tube conduit and an information line.

2. Discussion of the Background Art

In many cases, objects and systems which include gas conduits will require a leakage test. Known for this purpose are sampling leak detectors comprising a hand-guided sniffling probe which is connected to a suction means and to a gas detector. The object to be tested will be filled with a test gas, and test gas escaping from a leak will be sucked by the sniffling probe and detected by the gas detector. The sniffling probe is guided along the test object near various leak-prone points and on each of these points is stopped for a length of time suitable for measuring. The quality and leak-tightness, respectively, of an individual test object can be determined from the leakage rate of that measurement point which has the highest leakage rate, and/or from the sum of the leakage rates of the measurement points. Normally, the operating person will manually hold the sniffling probe in place on an individual measurement point while care must be taken that the sniffling probe is held as steadily as possible. As a reference for a good/bad-type statement, there is normally used a trigger value wherein, when this value is exceeded, a leak message will be triggered.

When localizing possible leaks, a sniffling probe simultaneously has to
be moved to spatially restricted leakage sites for the purposes of searching or localizing,
transmit feedback messages to the user, while the amount of the signal and possible fault conditions are displayed, and
allow for user action in dependence on the signal response.

In the above process, fault conditions must not be interpreted as “leak-free”.

It is an object of the disclosure to provide a sampling leak detector which is configured in a user-friendly manner and which allows the user to focus his or her attention still more closely on the test object and the guiding of the sniffling probe.

### SUMMARY OF THE DISCLOSURE

The sampling leak detector of the present disclosure comprises, in addition to the visual display means, a tactile indicator means and/or an acoustic indicator means for detection of gas and/or for leakage rate information. The user will be able, one the one hand, to read the result of the sampling leak detection process on the visual display belonging to the sniffling probe while, on the other hand, the user does not have to focus his or her full attention to the display means because the detection of a gas and/or a leakage rate information item will be communicated additionally via a bodily sensible (tactile) indicator means and/or an acoustic indicator means. In this manner, the information will be presented by the apparatus both in readable form in the user's field of view and also in a non-visual manner. Confusion of this information with a fault condition, e.g. with the condition “No display”, must be excluded.

With the disclosure, the incompatibility between a precise visual localization and a simultaneous perception of the trigger or detection information and of the leakage rate information, respectively, is eliminated. Upon occurrence of a corresponding signal which is generated optically and acoustically and respectively in a bodily sensible manner, the user will be enabled to first detect the mere presence of a leak as such and then, by moving the sniffling probe in the direction of an extreme value of the strength signal, to find the leakage site. The signals and the operating elements are combined in such a manner that, under different ambient conditions such as darkness, brightness, ambient noise etc., a detection by the user is guaranteed and an adequate reaction is rendered possible via operating elements arranged directly on the sniffling probe.

According to an advantageous embodiment of the disclosure, it is provided that the display means can be switched to a search mode in which, when a predetermined leakage rate is exceeded, a change of color occurs in the display means and a tactile indicator means is activated. In this manner, a distinction is made between searching and measuring. Thereby, it can also be safeguarded that a random measurement or erroneous measurement cannot interpreted as a leakage rate signal. When a predetermined leakage rate or a trigger value is exceeded, a change of color will occur in the display means. This change of color can either pertain to the whole background or only to a limited field within the display. According to an advantageous embodiment of the disclosure, it is provided that the display means can be switched to a localizing mode in which leakage rate information is displayed by means of a bar of variable length and a sound is generated which has a parameter depending on the leakage rate data. In this manner, the amount of the leakage rate can be brought to the user's attention both optically and acoustically. Consequently, even in the localizing mode, the user will not have to take a look at the display means. The user can fully focus his or her attention to the guiding of the sniffling probe and visually monitor the same.

According to an advantageous embodiment of the disclosure, a percentage display is provided which is controlled to display the value of 100% for leakage rate information which corresponds to the maximum value that occurred in a measurement process. In this respect, there is first detected and stored the maximum value which is reached during the scanning of the test object by the sniffling probe. Thereafter, the percentage of the leakage rate measured on the test object can be obtained in relation to 100% for each other measurement point. In this manner, it is rendered possible to measure the extension of a leak and the size of the leakage range of a leak, respectively. The percentage indication can be presented e.g. in the form of a bar graph or by an acoustic indicator means with variable pitch.

An embodiment of the disclosure will be described in greater detail hereunder with reference to the drawings.

### BRIEF DESCRIPTION OF THE DRAWINGS

In the drawings, the following is illustrated:

FIG. 1 is a schematic general view of the sampling leak detector, and

FIG. 2 shows an enlarged representation of the sniffling probe with the display means.

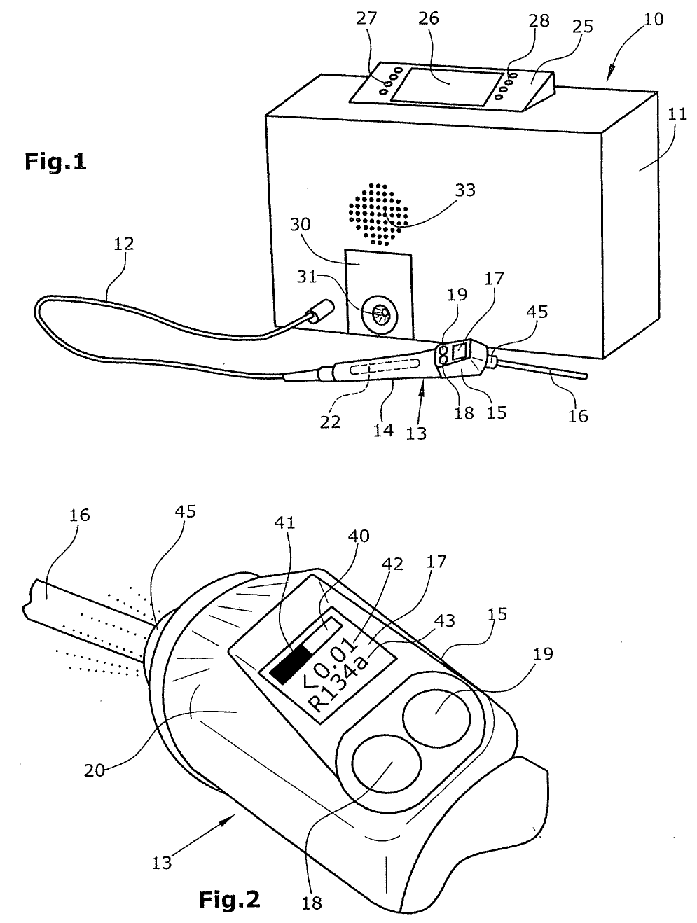

### DETAILED DESCRIPTION OF THE PREFERRED EMBODIMENT

The sampling leak detector comprises a basic device 10 which has a box-shaped housing 11 and can be placed near the measurement site. The basic device 10 is connected to the sniffling probe 13 via a tube conduit 12. The sniffling probe is a device adapted to be guided by hand, comprising a handle 14, an operating unit 15 and a rod-shaped thin sampling lance 16 extending from operating unit 15. Sampling lance 16 has a length at least twenty times as large as its outer diameter so that the lance can be introduced also into narrow gaps and holes. Formed on the free end of sampling lance 16 is a suction opening for suctional intake of gas. Operating unit 15 comprises a display means 17 and two operating keys 18,19. Display means 17 is arranged on lectern-like base 20, rendering it conveniently readable for the user holding the handle 14 in his or her hand. Sampling lance 16 is arranged obliquely under an angle relative to the surface of display means 17. The lance is also arranged obliquely to the longitudinal axis of handle 14, thus extending from operating unit 15 in the manner of a bird's beak.

Arranged internally of handle 14 is a tactile indicator means 22 in the form of a vibrator which can be activated to generate a bodily sensible vibratory movement on handle 14 for communicating information to the user.

Sniffling probe 16 and tube conduit 12 are operative to suck gas into basic device 10. Tube conduit 12 comprises, apart from the tube volume for the passage of the gas, an information line (not shown) by which a microprocessor included in basic device 10 can communicate with the electronics included in operating unit 15.

Basic device 10 on its box-shaped housing 11 is provided with a lectern-like protrusion 25 supporting a further display means 26. Adjacent to display means 26, two rows of keys 27,28 are arranged, allowing a menu control to be performed and an input process to be carried out.

Within basic device 10, a suction pump, a gas detector and an electronic control device are arranged. To gas detector can be e.g. a mass spectrometer adapted to detect a variety of gas types. Alternatively, use can be made of a infrared gas detector or another type of gas detector. In case of a mass spectrometer, said suction pump has to be provided in the form of a vacuum pump. The microcomputer which receives the signals of the gas detector and controls the display means 17 and 26, will deliver to the several display means a leakage rate signal as well as other signals which are required for the display.

Basic device 10 is provided with a removable test leak device 30 formed with an insertion opening 31 for the sampling lance 16. The test leak is adapted to have a defined leak rate of a specific gas supplied thereto. In this manner, calibration of the sampling leak detector can be performed.

Further provided on housing 11 is an acoustic indicator means 33 in the form of a current generator or a loudspeaker. The control process is provided to the effect that the pitch of the acoustic signal will vary corresponding to the leak rate information.

On the display monitor 17 of sniffling probe 13, a bar graph 40 can be displayed, with the bar 41 indicating a percentage of the amount of the leak rate information. The leak rate 43 is indicated as a numerical value. At 43, the gas type—here: R134a—is to be specified which will be displayed as well.

The key 18 at the operating unit 15 is a menu key for the display image presented by display means 17. Key 19 is a zero key by which the signal background of the measurement signal can be set to zero.

On operating unit 15, an illumination means 45 is provided to emit light along sampling lance 16 for thus illuminating the sampling tip and the surroundings thereof, respectively. This illumination can also be used to generate blinking signals. Thus, the user can concentrate his or her visual perception on the surroundings of the sampling tip.

The sampling leak detector can be switched to a search mode. When, in the search mode, a predetermined leakage rate is exceeded, this will entail a change in color on the display screen 17, e.g. from green to red. A corresponding change of color can also be generated in said further display means 26. The change of color indicates to the user that a leak has been detected; the changing color display does not, however, contain information on the size of the leak. Further, upon detection of a leak, the tactile indicator means 22 and the acoustic indicator means 33 will be activated.

Thereafter, the device is switched to the localizing mode. In the process, the display image illustrated in FIG. 2 is generated on display screen 17. In the localizing mode, bar graph 40 forms a percentage display which is controlled to display the value of 100% for a leakage rate information which corresponds to the maximum value occurring in a measurement process. While the user is guiding the tip of sampling lance 16 over the measurement object, the device continuously measures the amount of test gas flowing from the device under testing. For a test gas in the present case, gas of the type R134a is used. The maximum value is detected by a maximum-value detector and is stored. This value serves as a reference value during the further measurements. The reference value also determines the 100% value of bar graph 40.

In a similar manner, also another percentage display can provided which indicates the percentage in numerical form. In a percentage indicator means of the acoustic type, a specific high frequency will be used to indicate 100% while lower leakage rates will be indicated by deeper sounds.

By the device, it is safeguarded that there exists no fault condition which would generate a “normal” display. Each fault condition will, via the various display means, simultaneously generate the following:
blinking of the display background between bright and dark, or red and green,
blinking of the illumination of the tip of the sniffling probe,
an intermittent alarm sound in the form of a special melody,
interrupted vibration of the tactile indicator means.

If required, also a fault indication in the form of numbers, symbols or texts can be visualized on the display screen.

By use of said two keys 18,19 and assisted by the acoustic signals, the user is enabled, without direct visual contact to the sampling tip
to store the leakage rate value,
to switch the measurement mode from “search” to “localize”,
to acknowledge a fault message, and
to freeze the measurement value.

Also further types of action, not to be detailed here, can be performed. The same keys 18,19 are also provided for selecting the measurement modes or for setting melodies or other trigger actions.

1. A sampling leak detector, comprising
a sniffling probe to be guided by a user, comprising a handle and a display for displaying information on the detected leakage rate, and
a basic device comprising a suction device and a gas detector connected thereto, the sniffling probe being connected to the basic device via a tube conduit and an information line,
wherein in addition to said display, a tactile indicator and/or an acoustic indicator is/are provided for detection of a gas and/or for leakage rate information.

2. A sampling leak detector according to claim 1, wherein said display can be switched to a search mode wherein, when a predetermined leakage rate is exceeded, a change of color occurs in the display means, and said tactile indicator and/or said acoustic indicator is/are activated.

3. The sampling leak detector according to claim 1, wherein said display can be switched to a localizing mode wherein leakage rate information is displayed by a bar of variable length and a sound is generated which has a parameter depending on the leakage rate information.

4. A sampling leak detector according to claim 1, wherein a percentage display is provided which is controlled to display the value of 100% for leakage rate information corresponding to the maximum value that occurred in a measurement process.

5. The sampling leak detector according to claim 4, wherein said percentage display is a bar graph.

6. The sampling leak detector according to claim 4, wherein said percentage display is said acoustic indicator generating a frequency or a sound volume corresponding to the respectively measured percentage.

7. The sampling leak detector according to claim 1, wherein said tactile indicator comprises a vibrator arranged within the handle.

8. The sampling leak detector according to claim 1, wherein said sniffling probe comprises a rod-shaped sampling lance having a length at least twenty times the size of its outer diameter.

9. The sampling leak detector according to claim 1, wherein said basic device comprises a box-shaped housing provided with a further display arranged thereon in a lectern-like configuration.
